(19) United States
(12) Patent Application Publication
(10) Pub. No.: US 2005/0251767 A1
(43) Pub. Date: Nov. 10, 2005

(54) Processing of circuit design data

(76) Inventors: Gaurav R. Shah, Caldwell, ID (US); Denise S. Man, Fort Collins, CO (US)

Correspondence Address: HEWLETT-PACKARD COMPANY;Intellectual Property Administration, P.O. Box 272400, Fort Collins, CO, 80527-2400, US

(21) Appl. No.: 11/089,574

(22) Filed: May 7, 2004

(51) Int. Cl. G06F 17/50

(52) U.S. Cl. 716/4; 703/16; 716/7

(57) ABSTRACT

One example embodiment of an approach to circuit design analysis comprises partitioning a circuit design into first, second and boundary parts, the boundary part including circuit portions from each of the first part and second part at a boundary between the first part and second part. The first, second and boundary parts are independently simulated to generate a respective first, second and third set of result data that are combined to create a result for the design.

### BACKGROUND

Circuit designs are generally created and implemented using tools that generate information that is stored in one or more databases. This information may be accessed for analysis and testing of the design. Access to the information stored in the database typically involves the retrieval, assembly and analysis of data that represents the circuit design.

In some instances, relatively large circuit designs are analyzed for one or more of a variety of purposes, such as circuit recognition (e.g., verification of operation of the circuit). These relatively large circuit designs typically require a correspondingly large amount of memory if the entire circuit is to be analyzed. However, many analysis tools (e.g., computers) do not have enough memory to handle certain larger circuits. In addition, increasing the available memory can be quite expensive, particularly as designs become increasingly large in size.

In some applications involving the analysis of designs that are larger than available memory, the designs are broken into smaller pieces. Each of the smaller pieces is analyzed separately and the result is combined. Challenges to this approach arise, however, in accurately combining the separate analyses, particularly for logical circuits having portions thereof in separate ones of the smaller pieces.

### SUMMARY

According to an example embodiment of the present invention, circuit design data is partitioned into first, second and boundary parts. The boundary part includes circuit portions from each of the first part and second part at a boundary between the first part and second part (e.g., coupled to a common boundary port). The first, second and boundary parts are independently simulated to generate a respective first, second and third set of result data. These sets of result data are combined to create a result for the design.

It will be appreciated that various other embodiments are set forth in the Detailed Description and Claims that follow.

### BRIEF DESCRIPTION OF THE DRAWINGS

FIG. 1 is a flow diagram for an approach to circuit design analysis, according to example embodiments of the present invention;

FIG. 2 shows a block diagram of an approach for simulating a circuit design having a plurality of circuit blocks, according to example embodiments of the present invention;

FIG. 3 shows a block diagram for separately simulating boundary circuits within a circuit block, according to example embodiments of the present invention;

FIG. 4A shows an approach to processing a circuit design block with a functionally complete circuit within a boundary of the design block, according to example embodiments of the present invention;

FIG. 4B shows an approach to processing circuit design blocks with a functionally complete circuit split by a boundary between the design blocks, according to example embodiments of the present invention;

FIG. 5 shows an example arrangement and approach for processing circuit designs, according to example embodiments of the present invention;

FIG. 6 is a flow diagram for an approach to processing circuit design data, according to another example embodiment of the present invention; and

FIG. 7 is a flow diagram for an approach to circuit design analysis involving circuit recognition, according to another example embodiment of the present invention.

### DETAILED DESCRIPTION

According to an example embodiment of the present invention, a circuit design block is broken into circuit design partitions (CDPs), with each CDP having circuits therein. CDPs having circuits with a port on a boundary of the design block, referred to hereinafter as “boundary CDPs,” are processed separately from CDPs not having circuits with a port on the boundary (“non-boundary CDPs”). Some (or all) of the boundary CDPs are processed together using circuitry from within different CDPs from other design blocks sharing the same boundary port. Results from the processing of the boundary CDPs are recombined with results from the processing of non-boundary CDPs from the design block.

In another example embodiment, a circuit design is simulated (e.g., for circuit recognition and/or verification by way of analysis and simulation) using an approach similar to that discussed above, with the design being broken into circuit design blocks that are separately analyzed. Each design block is simulated, with results from non-boundary CDPs within each design block being stored. Each boundary CDP is combined, where appropriate, with a boundary CDP from another design block that shares a common port. Specifically, portions of functional CDPs existing on different sides of the boundary ports (e.g., in different design blocks) are combined to make functionally complete circuits.

In this instance, functionally complete, as applicable to circuit recognition, generally refers to circuits having individual circuit components coupled in a manner that facilitates circuit recognition (i.e., circuits used for generating a functionally analyzable output are combined). For example, when a particular functional circuit requires the use of a certain set of FETs combined in a particular manner (i.e., as defined by NETs) and when that set of FETs is coupled across a broken design block boundary, the set is separated and thus rendered functionally incomplete. When CDPs including portions of the set of FETs are combined, the separated set is made whole again (and functionally complete) such that analysis can be performed on the set as a unit.

Once the boundary CDPs are combined, circuit recognition is run on the combination and the results are also stored. The stored results from the combined boundary CDPs are then combined with the stored results from non-boundary CDPs for the design block. These combined results can be used to generate a result that includes all results for the circuit design (when all design blocks and CDPs are analyzed).

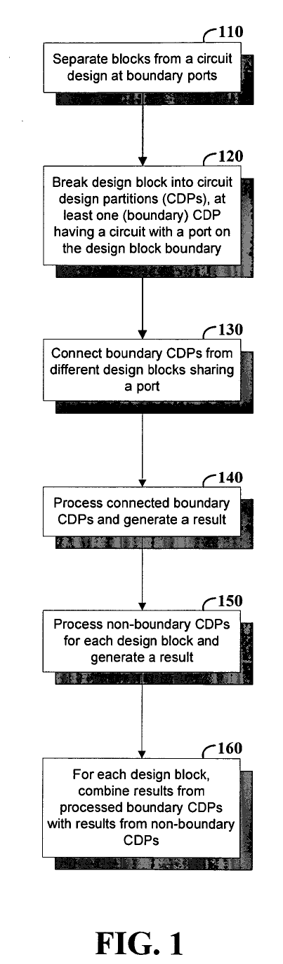

Turning now to the figures, FIG. 1 is a flow diagram showing an approach for simulating a circuit design, according to another example embodiment of the present invention. This simulation may involve, for example, one or more of determining the type of circuits in the design, determining connectivity of circuits in the design, determining functional characteristics of the design running test signals on the design or otherwise verifying characteristics of the design. At block 110, blocks are separated from a circuit design using, for example, the hierarchical structure of the design to identify the blocks. At block 120, boundary and non-boundary CDPs are partitioned from the design blocks. The CDPs may, for example, be partitioned from the design blocks in a manner similar to that described in connection with U.S. Pat. No. 6,499,129, which is fully incorporated herein by reference.

Boundary CDPs from different design blocks are connected at block 130. These boundary CDPs may include, for example, functional circuits having circuitry in two adjacent design blocks or, in some instances, a functionally compete circuit within a particular CDP but having a boundary port. Functionally complete CDPs are processed with other non-functionally complete boundary CDPs, i.e., when boundary CDPs are identified as any CDP having a circuit with a boundary port, even if that circuit is functionally within the CDP. At block 140, connected boundary CDPs are processed and a result is generated therefrom. Non-boundary CDPs for each design block are processed at block 150, with a result similarly being generated. Optionally, the non-boundary CDPs are processed as discussed with block 150 prior to the boundary CDPs being processed as discussed with block 140 and, in other instances, before the boundary CDPs are connected as discussed with block 130 (i.e., the order of these steps may be changed). At block 160, and for each design block, results from the processed boundary and non-boundary CDPs are combined to form a general result for the circuit design.

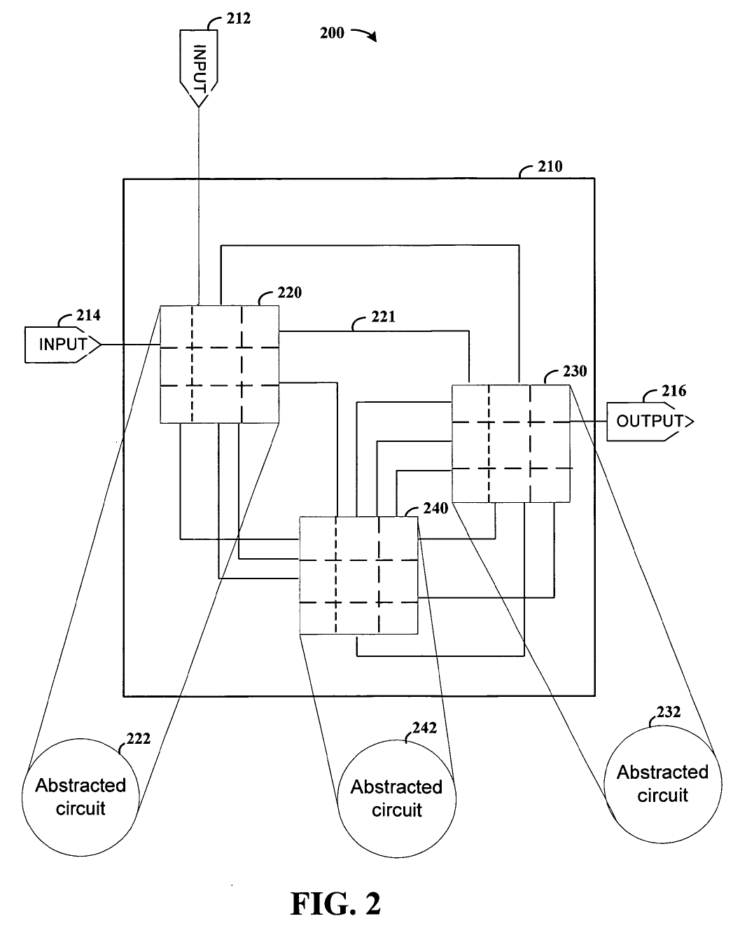

FIG. 2 shows a block diagram for use in simulating a circuit design having a plurality of circuit design blocks, according to another example embodiment of the present invention. The block diagram shown in FIG. 2 and the following discussion regarding FIG. 2 may be implemented, for example, using an approach similar to that shown in and discussed in connection with the flow diagram of FIG. 1. Circuit design 210 represents data for a circuit design, or part of a circuit design, having a variety of hierarchical blocks that are desirably broken into smaller pieces for processing. For instance, circuit design 210 may be too large to run through a circuit recognition engine for a particular application. In this regard, breaking design block 210 into smaller circuit blocks facilitates processing of the information within the design in smaller pieces. In addition, these smaller circuit blocks can be processed separately and, in some instances, processed concurrently.

In this instance, the circuit design 210 has circuit design blocks including design blocks 220, 230 and 240, each of which includes a multitude of circuits and, in some instances, other hierarchical blocks that in turn have additional circuits. Input ports 212 and 214 are coupled to design block 220, and output port 216 is coupled to design block 230. The design blocks within the circuit design 210 are coupled to other design blocks in a manner indicated by NETs for the design, with the NETs being represented by the interconnecting lines between the design blocks. Referring to design blocks 220 and 230 as an example, interconnecting line 221 represents a NET that describes the interconnection between the design blocks (e.g., the NET 221 identifies a pin, with each design block 220 and 230 being coupled to the same pin and thus to each other).

Each of the design blocks 220, 230 and 240 is partitioned into CDPs using, for example, an approach similar to that discussed above. Each CDP is flattened for analysis (i.e., the hierarchical nature of circuitry in each CDP is removed and replaced by coupling the circuits together). This flattened circuit can then be processed for analysis, such as circuit recognition and verification.

For each of the design blocks 220, 230 and 240, CDPs having a port on the boundary of the design block (boundary CDPs) are identified and abstracted respectively into abstracted circuits 222, 232 and 242. These abstracted boundary CDPs are then combined such that boundary CDPs in each abstracted circuit that share a port can be coupled. For example, referring again to design blocks 220 and 230 and NET 221 as an example, CDPs from each design block 220 and 230 that are coupled to the NET 221 are considered boundary CDPs).

The boundary CDPs are coupled and subsequently processed for analysis. For example, each of the abstracted circuits 222, 232 and 242 may be collected and used to form an abstracted circuit block that can be processed in its entirety. Other non-boundary CDPs in each of design blocks 220, 230 and 240 are also processed for analysis, with the results being combined with results from the analysis of the boundary CDPs.

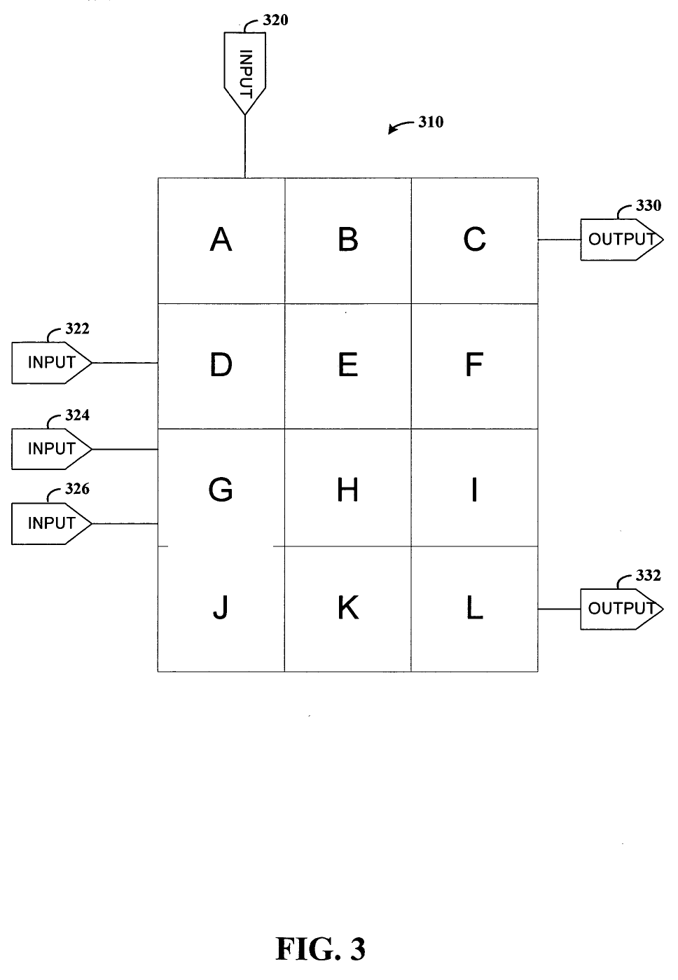

FIG. 3 shows a block diagram for simulating CDPs A-L within a block 310 of a larger circuit design, according to another example embodiment of the present invention. The design block 310 may be analyzed, for example, in connection with the approach shown in FIG. 2 and discussed above, with circuit design block 310 implemented as one of design blocks 220, 230 or 240. In this instance, CDPs A, C, D, G and L are boundary CDPs coupled to input or output ports as shown at a boundary of the design block 310. Specifically, input port 320 is coupled to CDP A, output port 330 is coupled to CDP C, input port 322 is coupled to CDP D, input ports 324 and 326 are coupled to CDP G and output port 332 is coupled to CDP L. The remaining CDPs not coupled to ports on the boundary (B, E, F and H-K) are thus non-boundary CDPs (and include, e.g., circuits that are functionally complete within each CDP in the context of the above discussion).

When design block 310 is analyzed, each of the non-boundary (and, e.g., functionally complete) CDPs (B, E, F and H-K) is processed for circuit recognition and/or another type of analysis, and the results are stored. An abstraction is performed, wherein boundary circuits in each of the boundary CDPs (A, C, D, G and L) are coupled at common ports with other boundary circuits from other boundary CDPs in other design blocks. For instance, the identification (e.g., pin number) of the input and output ports can be used to determine where to couple circuits from different design blocks with boundary circuits in the boundary CDPs A, C, D, G and L. Other boundary circuits from CDPs in other design blocks are similarly coupled to boundary circuits sharing other common ports. These coupled boundary circuits (and CDPs) are combined to form an abstracted circuit having functionally complete CDPs as discussed, for example, in connection with the abstracted circuits 222, 232 and 242 of FIG. 2.

In some instances, all boundary CDPs in a particular design are coupled to form an abstracted circuit. This abstracted circuit is then processed to generate a result that is representative of all of the boundary CDPs within the design, including boundary CDPs A, C, D, G and L in design block 310 as well as those in other design blocks.

In other instances, the boundary CDPs of a particular design are coupled to form two or more abstracted circuits, with the two or more abstracted circuits being coupled via abstracted boundary circuits coupled to a common port. This approach may be useful in instances where processing all of the boundary CDPs within a particular design at once is not desirable, such as when a particular abstracted circuit is larger than a desirably sized circuit (and partitioning the abstracted circuit generates a functionally incomplete circuit). Referring to FIG. 2 as an example, this approach would involve the combination of two or more of abstracted circuits 222, 232 and/or 242 into a single abstracted circuit having both boundary and non-boundary circuits. The non-boundary circuits within the combination are processed separately, and the boundary circuits are again abstracted and combined with other abstracted boundary circuits at common ports. This successive abstracted circuit is processed and the results are recombined with the results from the other abstracted circuits as well as the analysis of other abstracted CDPs to form a complete analysis of all boundary circuits in the design. These results from the boundary circuits are combined with processed results from non-boundary circuits within the design to create a result from the entire design.

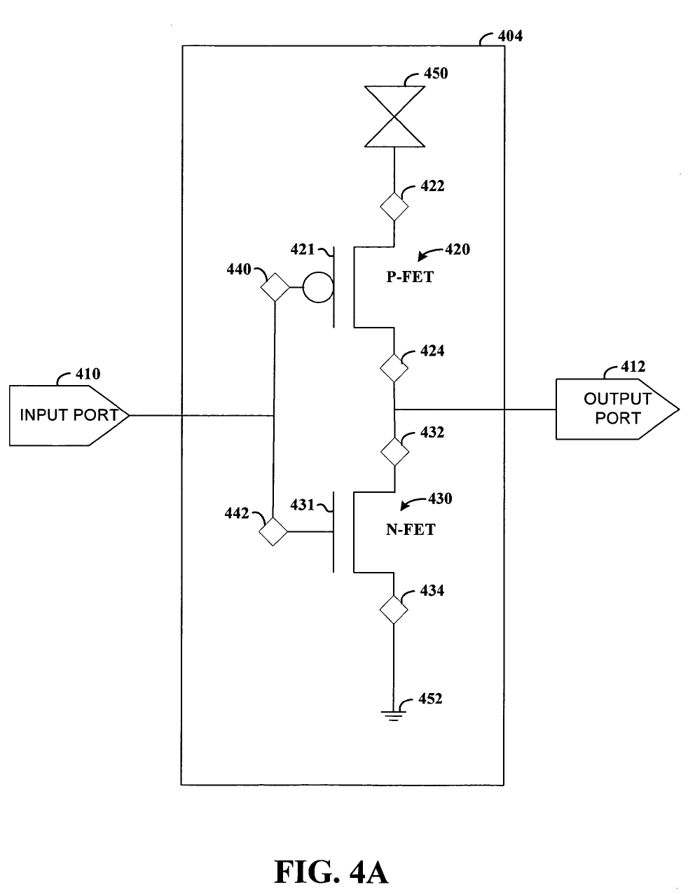

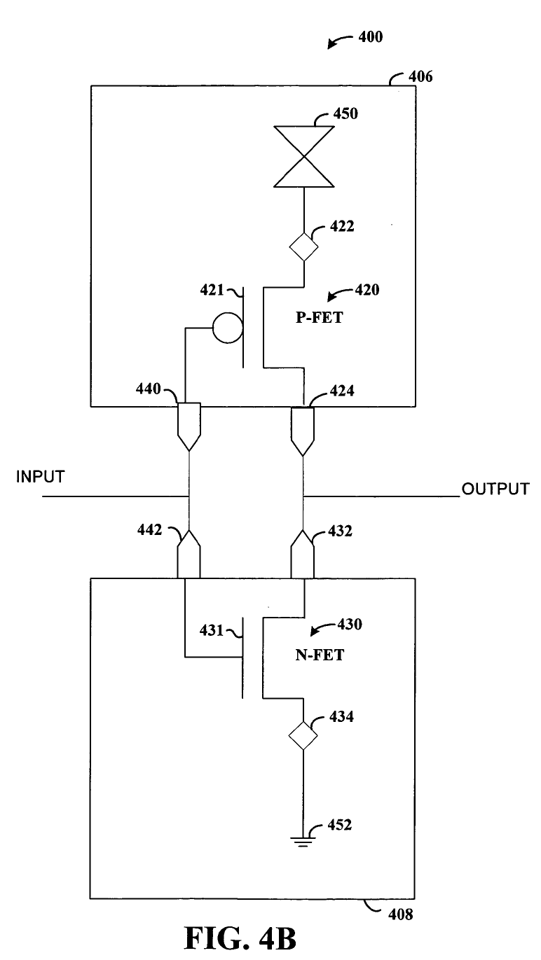

FIGS. 4A and 4B show two approaches to processing circuit designs as may be implemented, for example, in connection with one or more of the example embodiments discussed above in connection with FIGS. 1-3. Referring first to FIG. 4A, an inverter circuit 400 is separated from other circuits in a design at a block boundary 404. The inverter circuit includes a P-FET 420 and an N-FET 430 with gates coupled via pins 440 and 442 and source/drain regions coupled at pins 424 and 432. The P-FET 420 is coupled to a voltage source VDD 450 at pin 422, and the N-FET 430 is coupled to ground 452 at pin 434. An input port 410 is coupled to the gates of each of the P-FET 420 and N-FET 430 respectively via pins 440 and 442. An output port 412 is coupled to pins 424 and 432 for passing an output from the inverter circuit 400 to other circuits in the design. The connections between the various circuit portions in FIG. 4A are described with NETs for the circuit design of which inverter circuit 400 is a part.

With the block boundary 404, the inverter circuit 400 is functionally complete and within the boundary of the block; thus the analysis of the block will be a complete analysis of the function of the inverter circuit in response to inputs via input port 410. In this regard, the inverter circuit 400 may be represented and processed in a manner similar to that shown for circuit portions “E” or “H” in FIG. 3. Specifically, none of the ports (or pins) for either P-FET 420 or N-FET 430 are on a boundary and thus the inverter circuit 400 is functionally complete within the boundary 404. Accordingly, the inverter circuit 400 can be processed when the block identified by block boundary 404 is processed.

Referring now to FIG. 4B, the inverter circuit 400 is shown separated into two circuit blocks having block boundaries 406 and 408. Each of ports 440, 442, 424 and 432 are effectively on the boundary between boundary circuit blocks 406 and 408. Ports 440 and 442 share an input (ie., and function similarly to input port 410 of FIG. 4A), and ports 424 and 432 share an output (i.e., and function similarly to output port 412 of FIG. 4A). In this instance, P-FET 420 and N-FET 430 within block boundaries 406 and 408 are not functionally complete. Specifically, the inverter circuit 400 requires circuit portions from each of the blocks identified by block boundaries 406 and 408. In this regard, these circuits are abstracted and combined to form part of a boundary circuit, prior to processing. Once complete, the analysis of this boundary circuit is combined with the analysis of other circuitry (e.g., in block boundaries 406 and 408 or elsewhere) to complete the analysis of the design.

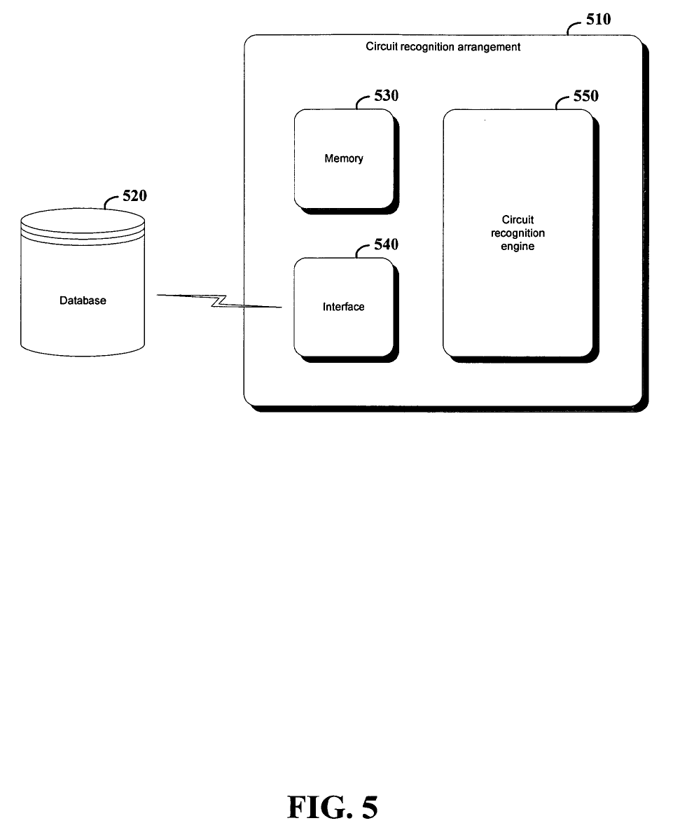

FIG. 5 shows an example arrangement and approach for processing circuit designs, according to another example embodiment of the present invention. A circuit recognition arrangement 510 includes a circuit recognition engine (CRE) 550, memory 530 and an interface 540. A database 520 is adapted to store circuit design information for access by the interface 540. When a particular circuit design is to be analyzed, blocks from the design are retrieved via the interface 540 and stored in the memory 530. The CRE 550 (i.e., a processor) accesses the block information from the memory 530 as an input (e.g., in the form of a netlist) and flattens the netlist from a hierarchical form into a two-dimensional form in which block hierarchy is replaced by representative circuit connections of FETs and NETs.

In some instances, designs stored in the database 520 are too large to fit in the memory 530 when flattened into a two-dimensional circuit form and processed. In other instances, it is desirable to run circuit recognition on portions of a design rather than the design in its entirety, even if the design (or processed version of the design) would fit in memory 530. In this regard, the CRE 550 is adapted to run circuit recognition on less than the entire design using, for example, one or more of the approaches discussed above to reduce the size of the part of the design being processed.

The CRE 550's is programmable for reducing the size (partitioning) of the design using a variety of approaches. In one example, the CRE 550 partitions the design as a function of the available memory or desired memory usage (i.e., the size of the circuit design part, or CDP, can be made smaller than a selected memory size). In another example, the CRE 550 partitions the design as a function of a desired processing speed for each design part. In still another example, the CRE 550 partitions the design as a function of desired processor usage (i.e., where a processor desirably devotes only a selected amount of processing capability to processing each design part).

In another implementation, the CRE 550 partitions the flattened design into CDPs, which can be analyzed for their content one by one and stored in the database 520 for future reference, with each CDP being correlated with its corresponding block (and retrievable via information for the block). Non-boundary CDPs can be directly processed and the results stored in the database 520. Boundary CDPs are abstracted and joined with at least one other CDP sharing a common port, the combination analyzed and the results also stored in the database 520.

In a more particular implementation, two or more processors are used to separately process blocks from a circuit design. Using an approach similar to that discussed above in connection with FIG. 5, the design is broken into blocks that are smaller than the whole of the design, with different blocks being processed at different processors (e.g., each processor having a CRE 550). With this approach, the circuit design blocks can be simultaneously processed to facilitate the generation of results in parallel for a particular circuit design. These results are then combined to generate a result for the circuit design, with the simultaneous processing of the blocks speeding the processing of the entire design. In some instances, further speed is realized using a multitude of processors operating in parallel.

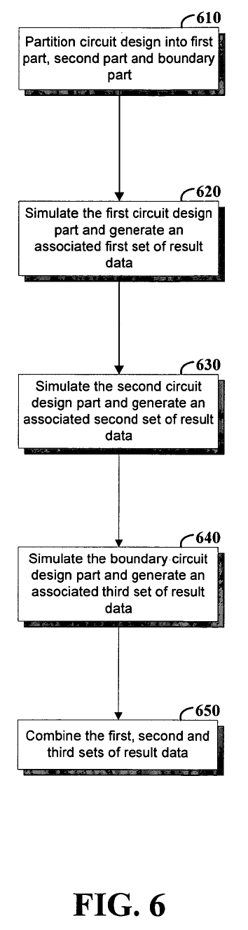

FIG. 6 is a flow diagram for an approach to processing circuit design data, according to another example embodiment of the present invention. At block 610, circuit design data is partitioned into at least a first part, a second part and a boundary part, the boundary part including circuit portions from each of the first part and second part at a boundary between the first part and second part. At block 620, the first circuit design part is simulated and an associated first set of result data is generated. At block 630, the second circuit design part is simulated, independent of analysis of the first circuit design part, and a second set of result data is generated. At block 640, the boundary circuit design part is simulated independent of simulating the first and second circuit design parts, and a third set of result data is generated. The first, second and third sets of result data are then combined at block 650.

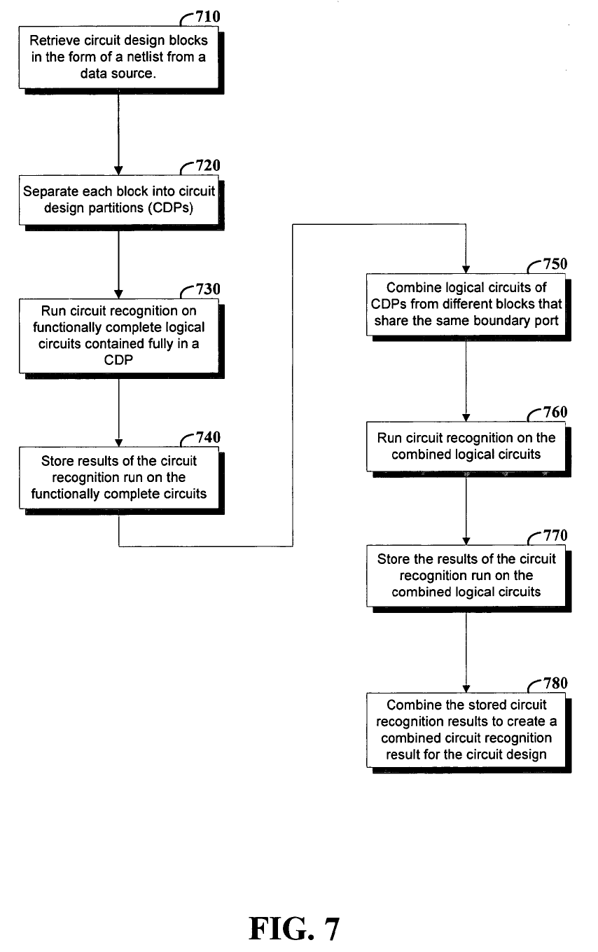

FIG. 7 is a flow diagram for an approach to circuit recognition-type analysis for a circuit design having a plurality of blocks, according to another example embodiment of the present invention. At block 710, circuit design blocks are retrieved in the form of a netlist from a data source. Each block is separated into circuit design partitions (CDPs) at block 720, each CDP including circuit components of the block from which it was separated. At block 730, circuit recognition analysis is run on CDPs having functionally complete logical circuits contained fully in the CDP, with the results of the circuit recognition analysis stored at block 740. At block 750, for each CDP having a boundary port on a boundary of a block, logical circuits from the CDP are combined with logical circuits from another CDP from another block that shares the boundary port. Circuit recognition analysis is run on the combined logical circuits at block 760 and the results are stored at block 770. At block 780, the stored circuit recognition results from the functionally complete circuits and from the boundary circuits are combined to create a combined circuit recognition result for the circuit design.

Those skilled in the art will appreciate that various alternative computing arrangements would be suitable for hosting the processes of the different embodiments of the present invention. For example, the processes may be implemented on single processor, multi-processor, parallel processor, or an arrangement of processors on a local area network. In addition, the processes may be provided via a variety of computer-readable media or delivery channels such as magnetic or optical disks or tapes, electronic storage devices, or as application services over a network.

The present invention is believed to be applicable to a variety of circuit recognition and verification-type arrangements and approaches and has been found to be particularly applicable and beneficial in presenting a consistent interface for use with different data sources. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

1. A method for processing circuit design data, the method comprising:
partitioning the circuit design data into at least a first part, a second part and a boundary part, the boundary part including circuit portions from each of the first part and second part at a boundary between the first part and second part;
simulating the first part and generating an associated first set of result data;
simulating the second part independent of analysis of the first part and generating a second set of result data;
simulating the boundary part independent of simulating the first part and the second part and generating a third set of result data; and
combining the first, second, and third sets of result data.

2. The method of claim 1, wherein partitioning the circuit design data into a first part and a second part includes partitioning the circuit design data into a first part from a first design block and into the second part from a second design block that is distinct from the first design block, the first and second design blocks being coupled at a port of the boundary part.

3. The method of claim 2, wherein partitioning the circuit design into a first part from a first design block includes partitioning the first design block into a plurality of parts, one of the plurality of parts being the first part, wherein ones of the plurality of parts having a port on a boundary of the first design block are processed separately from ones of the plurality of parts not having a port on the boundary of the design block.

4. The method of claim 1, wherein:
partitioning the circuit design data into at least a first part, a second part and a boundary part includes partitioning at least two blocks of the circuit design data that share at least one port into circuit design partitions (CDPs), each CDP including circuit components of each block;
simulating the first part and generating an associated first set of result data includes simulating CDPs of a first one of the blocks, the CDPs not having a port on a boundary between the at least two blocks; and
simulating the boundary part independent of simulating the first part and the second part and generating a third set of result data includes coupling boundary CDPs that share a common boundary port and simulating the coupled boundary CDPs.

5. The method of claim 4, wherein coupling boundary CDPs includes combining a plurality of boundary CDPs, each combination including at least two boundary CDPs sharing a common port.

6. The method of claim 4, wherein coupling boundary CDPs includes combining first, second and third boundary CDPs, the first and second boundary CDPs coupled via a first port and the second and third boundary CDPs coupled via a second port and wherein simulating the boundary part comprises:
breaking the combined boundary CDPs into at least two parts and a boundary part, the boundary part including one of the first and second ports and including circuitry from each of the at least two parts coupled to the one of the first and second ports; and
separately simulating the boundary part and the at least two parts to generate the boundary result data.

7. The method of claim 1, wherein simulating the first part and simulating the second part includes simulating parts of the circuit design not having a port on a boundary of a block and generating non-boundary result data and wherein simulating the boundary part includes simulating components of the circuit design having a port on a boundary of a block.

8. The method of claim 7, further comprising concurrently simulating at least two parts of the circuit design and separately generating result data for each of the at least two parts.

9. The method of claim 8, wherein concurrently simulating at least two parts of the circuit design includes concurrently simulating a boundary part and a non-boundary part.

10. The method of claim 8, wherein concurrently simulating at least two parts of the circuit design includes concurrently simulating at least two boundary parts.

11. The method of claim 8, wherein concurrently simulating at least two parts of the circuit design includes concurrently simulating at least two non-boundary parts.

12. The method of claim 8, wherein concurrently simulating at least two parts of the circuit design includes separately simulating the at least two parts of the circuit design at different processors and generating result data at each of the different processors.

13. The method of claim 1, wherein partitioning the circuit design data includes partitioning the circuit design data into different parts as a function of a selected amount of memory space to be used for simulating the parts.

14. The method of claim 1, wherein partitioning the circuit design data includes partitioning the circuit design data into different parts as a function of a selected amount of memory space to be used for simulating the boundary part.

15. The method of claim 1, wherein partitioning the circuit design data includes partitioning the partitioning the circuit design data into parts as a function of a selected analysis speed for simulating the parts.

16. The method of claim 1, wherein simulating the first part, the second part and the boundary part and generating a set of result data for each includes running circuit recognition on the parts and generating circuit recognition result data.

17. A method for processing a circuit design having a plurality of blocks for circuit recognition, the method comprising:
retrieving circuit design blocks in the form of a netlist from a data source;
for each block, separating the block into circuit design partitions (CDPs), each CDP including circuit components of the block;
running circuit recognition analysis on CDPs comprising functionally complete logical circuits contained fully in the CDP and storing the results of the circuit recognition analysis;
for each CDP having a boundary port on a boundary of a block, combining logical circuits from the CDP with logical circuits from another CDP from another block that shares the boundary port;
running circuit recognition analysis on the combined logical circuits and storing the results; and
combining the stored circuit recognition results and creating a combined circuit recognition result for the circuit design.

18. The method of claim 17, further comprising using the combined circuit recognition result for simulating functions of the circuit design.

19. A system for processing circuit design data, the system comprising:
means for partitioning the circuit design data into at least a first part, a second part and a boundary part, the boundary part including circuit portions from each of the first part and second part at a boundary between the first part and second part;
means for simulating the first part and generating an associated first set of result data;
means for simulating the second part independent of analysis of the first part and generating a second set of result data;
means for simulating the boundary part independent of simulating the first part and the second part and generating a third set of result data; and
means for combining the first, second, and third sets of result data.

20. A system for processing circuit design data, the system comprising:
a partition function adapted to partition the circuit design data into at least a first part, a second part and a boundary part, the boundary part including circuit portions from each of the first part and second part at a boundary between the first part and second part;
a simulation function adapted to:
simulate the first part and generate an associated first set of result data;
simulate the second part independent of analysis of the first part and generate a second set of result data;
simulate the boundary part independent of simulating the first part and the second part and generate a third set of result data; and
a combination function adapted to combine the first, second, and third sets of result data.

21. The system of claim 20, wherein the simulation function is implemented with at least two separate processors adapted to simultaneously process at least two of the circuit design parts and wherein the combination function is adapted to combine result data from the at least two separate processors.

22. The system of claim 20, wherein the partition function is adapted to partition each of the first part and the second part into a plurality of circuit design partitions (CDPs) and wherein the simulation function is adapted to simulate ones of the CDPs coupled to a common boundary port by combining the ones of the CDPs at the common boundary port and simulating the combination.

23. The system of claim 20, wherein the partition function is adapted to partition each of the first part and the second part and the boundary part into circuit design partitions (CDPs) that are small enough to fit in a selected memory available to the simulation function for simulating the CDPs.

24. The system of claim 20, wherein the partition function is adapted to partition each of the first part and the second part and the boundary part into circuit design partitions (CDPs) that are small enough to process at a selected speed.

25. A program storage device, comprising:
a processor-readable medium configured with instructions executable by the processor for demoting a page in virtual memory by performing the operations of:
partitioning the circuit design data into at least a first part, a second part and a boundary part, the boundary part including circuit portions from each of the first part and second part at a boundary between the first part and second part;
simulating the first part and generating an associated first set of result data;
simulating the second part independent of analysis of the first part and generating a second set of result data;
simulating the boundary part independent of simulating the first part and the second part and generating a third set of result data; and
combining the first, second, and third sets of result data.

26. The program storage device of claim 25, wherein the processor-readable medium is further configured with instructions for performing the operation of partitioning the circuit design data into a first part and a second part by partitioning the circuit design data into a first part from a first design block and into the second part from a second design block that is distinct from the first design block, the first and second design blocks being coupled at a port of the boundary part.

27. The program storage device of claim 26, wherein the processor-readable medium is further configured with instructions for performing the operation of partitioning the circuit design into a first part from a first design block by partitioning the first design block into a plurality of parts, one of the plurality of parts being the first part, wherein ones of the plurality of parts having a port on a boundary of the first design block are processed separately from ones of the plurality of parts not having a port on the boundary of the design block.

28. The program storage device of claim 25, wherein the processor-readable medium is further configured with instructions for performing the operation of:
partitioning the circuit design data into at least a first part, a second part and a boundary part by partitioning at least two blocks of the circuit design data that share at least one port into circuit design partitions (CDPs), each CDP including circuit components of each block;
simulating the first part and generating an associated first set of result data by simulating CDPs of a first one of the blocks, the CDPs not having a port on a boundary between the at least two blocks; and
simulating the boundary part independent of simulating the first part and the second part and generating a third set of result data by coupling boundary CDPs that share a common boundary port and simulating the coupled boundary CDPs.

29. The program storage device of claim 28, wherein the processor-readable medium is further configured with instructions for performing the operation of coupling boundary CDPs by combining a plurality of boundary CDPs, each combination including at least two boundary CDPs sharing a common port.

30. The program storage device of claim 28, wherein the processor-readable medium is further configured with instructions for performing the operations of:
coupling boundary CDPs by combining first, second and third boundary CDPs, the first and second boundary CDPs coupled via a first port and the second and third boundary CDPs coupled via a second port; and
simulating the boundary part by breaking the combined boundary CDPs into at least two parts and a boundary part, the boundary part including one of the first and second ports and including circuitry from each of the at least two parts coupled to the one of the first and second ports, and separately simulating the boundary part and the at least two parts to generate the boundary result data.

31. The program storage device of claim 25, wherein the processor-readable medium is further configured with instructions for performing the operations of:
simulating the first part and simulating the second part by simulating parts of the circuit design not having a port on a boundary of a block and generating non-boundary result data; and
simulating the boundary part by simulating components of the circuit design having a port on a boundary of a block.

32. The program storage device of claim 31, wherein the processor-readable medium is further configured with instructions for performing the operation of concurrently simulating at least two parts of the circuit design and separately generating result data for each of the at least two parts.

33. The program storage device of claim 32, wherein the processor-readable medium is further configured with instructions for performing the operation of concurrently simulating at least two parts of the circuit design by concurrently simulating a boundary part and a non-boundary part.

34. The program storage device of claim 32, wherein the processor-readable medium is further configured with instructions for performing the operation of concurrently simulating at least two parts of the circuit design by concurrently simulating at least two boundary parts.

35. The program storage device of claim 32, wherein the processor-readable medium is further configured with instructions for performing the operation of concurrently simulating at least two parts of the circuit design by concurrently simulating at least two non-boundary parts.

36. The program storage device of claim 32, wherein the processor-readable medium is further configured with instructions for performing the operation of concurrently simulating at least two parts of the circuit design by separately simulating the at least two parts of the circuit design at different processors and generating result data at each of the different processors.

37. The program storage device of claim 25, wherein the processor-readable medium is further configured with instructions for performing the operation of partitioning the circuit design data by partitioning the circuit design data into different parts as a function of a selected amount of memory space to be used for simulating the parts.

38. The program storage device of claim 25, wherein the processor-readable medium is further configured with instructions for performing the operation of partitioning the circuit design data by partitioning the circuit design data into different parts as a function of a selected amount of memory space to be used for simulating the boundary part.

39. The program storage device of claim 25, wherein the processor-readable medium is further configured with instructions for performing the operation of partitioning the circuit design data by partitioning the partitioning the circuit design data into parts as a function of a selected analysis speed for simulating the parts.

40. The program storage device of claim 25, wherein the processor-readable medium is further configured with instructions for performing the operation of simulating the first part, the second part and the boundary part and generating a set of result data for each by running circuit recognition on the parts and generating circuit recognition result data.
